(19) United States
(12) Patent Application Publication
(10) Pub. No.: US 2025/0262629 A1
(43) Pub. Date: Aug. 21, 2025

(54) Fountain Attachment for Water Features

(71) Applicant: OASE GmbH, Hörstel-Riesenbeck (DE)

(72) Inventor: Thorsten Muck, Castellefe (ES)

(73) Assignee: OASE GmbH, Hörstel-Riesenbeck (DE)

(21) Appl. No.: 19/052,737

(22) Filed: Feb. 13, 2025

(30) Foreign Application Priority Data
Feb. 21, 2024 (DE) 10 2024 104 905.7

(51) Int. Cl. B05B 1/26; B05B 1/12; B05B 17/08

(52) U.S. Cl. CPC B05B 1/26; B05B 1/12; B05B 17/08

(57) ABSTRACT

A fountain attachment for water features having an adjustable nozzle for producing dynamic water images at the nozzle outlet, the nozzle having at least one outer nozzle tube (3) and an inner nozzle body (5), has at least one effect attachment (1) which is detachably connected to the outer nozzle tube (3) in the region of the nozzle outlet and has a plurality of apertures (7) which divide a goblet-like water jet into individual jets. There may also be an effect attachment (2) detachably connected to the inner nozzle body (5) in the area of the nozzle outlet.

### CROSS REFERENCE TO RELATED APPLICATIONS

This application claims priority under 35 U.S.C. § 119 to German Patent Application DE 10 2024 104 905.7, filed Feb. 21, 2024, which is herein incorporated by reference in its entirety, including without limitation, the specification, claims, and abstract, as well as any figures, tables, appendices, or drawings thereof.

### FIELD OF THE INVENTION

The present invention relates to a fountain attachment for water features with an adjustable nozzle for generating dynamic water images.

### BACKGROUND OF THE INVENTION

The background description provided herein gives context for the present disclosure. Work of the presently named inventors and aspects of the description that may not otherwise qualify as prior art at the time of filing are neither expressly nor impliedly admitted as prior art.

Fountain attachments have at least one outer nozzle tube and one inner nozzle body, between which interaction can take place, so that the resulting water image can vary between a fairly compact full jet and a fan-like outwardly spreading or goblet-like water image in various forms. Such fountain attachments are known, for example, from DE 10 2018 119 424 A1 or DE 10 2013 005 972 A1.

### SUMMARY OF THE INVENTION

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

A primary object of the invention is to create a fountain attachment that enables water images with even greater variance.

The present invention relates to a fountain attachment for water features having an adjustable nozzle for producing dynamic water images at the nozzle outlet; the nozzle having at least one outer nozzle tube and one inner nozzle body, characterized by at least one effect attachment which is detachably connected to the outer nozzle tube (3) in the region of the nozzle outlet and has a plurality of apertures which divide a goblet-like water jet into individual jets.

By means of an effect attachment that has a number of apertures, in particular, apertures with a radial directional component, a goblet-like water jet or a funnel-like water image is divided into individual jets. This requires at least one effect attachment, which is firmly connected to the outer nozzle tube of the fountain attachment in the area of the nozzle outlet. The connection must be fixed but detachable. In this way, one effect attachment can be replaced with another effect attachment, which in turn enables other water images to be created by means of a different design, particularly the apertures.

Preferably, the effect ring can be connected to the outer nozzle tube by screwing it onto the latter, whereby screwing on includes several alternatives, such as an internal thread in the effect ring or an external thread on the effect ring interacting with an internal thread in the outer nozzle tube or also plug-and-twist connections such as a bayonet lock. All types of connections, including a plug-in connection, for example, can be secured using pins or lateral fixing screws. In a technically simple manner and easy to handle for replacement, the effect ring can be designed in particular in the manner of a union nut. The effect attachment can essentially close off the top of the nozzle at the nozzle outlet. It can, however, also be designed as an effect ring. The effective apertures are then arranged in the ring rim in particular. Some or all apertures can be opened on the water outlet side.

The effect attachment or the effect attachments used in each case can be designed very differently, depending on which water images are to be created. The apertures of the effect attachment can be of different sizes and/or shapes, even within one effect attachment. It is also possible for the apertures of the effect attachment to have different heights, for example, a lower and a higher aperture in alternation. It is also possible for the apertures to be located at different heights of the effect attachment in a longitudinal direction of the nozzle, in particular alternately. One aperture, for example, can be arranged in the upper area of the effect attachment and open at the top, while the adjacent aperture extends in the manner of a tunnel or bridge passage in a lower area. All variants of apertures can be combined with each other in one effect element or in different effect elements. A spatial indication “top” always refers to the water outlet side of the nozzle or to the top side if the nozzle is positioned vertically.

In one embodiment of the effect attachment, the apertures can be spaced apart from one another by separating elements which taper radially inwards towards the center of the nozzle outlet. The separating elements or separating webs can preferably be designed in a fluidically favorable way so that the water jet is divided with little friction. Jet guiding elements can be connected radially outwards to the separating elements. These can help to maintain a sharp separation of the water jet in the direction of the jet for a long stretch. The jet guiding elements can be shovel-like and designed in a shovel-like manner, and if desired, they can direct the individual jets even more strongly in a predetermined direction.

The attachment connected to the outer nozzle tube can completely span the nozzle on its outlet side. It is also possible to arrange an effect attachment also fixed but detachably connected to the inner nozzle body in the area of the nozzle outlet, wherein the effect attachment again has a plurality of apertures, which in this case divide a central water jet into several individual jets. This can be an additional effect attachment; however, it can also be formed in one piece, with the first effect attachment connected to the outer nozzle tube.

The effect attachment connected to the inner nozzle body can be a nozzle plate which is perforated with apertures in the longitudinal direction of the nozzle. The apertures can vary in diameter, both from aperture to aperture and within an aperture itself. If the apertures taper towards the water outlet side, an even stronger bundling of the emerging water jets is created.

The fountain attachment, according to the invention, can also be provided with an effect attachment designed as a rotating nozzle. The effect attachment has outlet channels that are directed at least essentially radially outwards in relation to the longitudinal axis of the nozzle, i.e., these have a clear horizontal component when the longitudinal axis of the nozzle is vertical, as a result of which the water jets are deflected essentially horizontally. Especially in combination with a rotating nozzle, an interesting, spiral-shaped water image is created. Preferably, such a rotary nozzle is closed in a longitudinal direction of the nozzle so that a central water outlet is prevented and all escaping water is deflected to the side.

In a preferred embodiment, the outlet ducts are each inclined or slanted relative to a radial in relation to a plane perpendicular to the longitudinal axis of the nozzle. The emerging water, therefore, does not spray exactly radially out of the nozzle, but creates a wind rose effect even without rotating the nozzle itself.

Fountain attachments with rotating nozzles, according to the invention, can be used in particular in conjunction with swivel drives for fountain attachments, such as those from DE 10 2008 018 118. Thereby, the entire fountain attachment can be rotated. Irrespective of this, it is also possible to design the effect attachment in such a way that it is rotatably mounted, wherein the arrangement of the outlet channels causes the effect attachment to rotate automatically when exposed to the water jet supplied to the nozzle.

The fountain attachment with effect attachment, according to the invention, advantageously complements the selected adjustable nozzle to form a multifunctional nozzle with variable water images. It is particularly advantageous to adjust the nozzle by displacing the outer nozzle tube relative to the inner nozzle body in a longitudinal direction of the nozzle, especially if this displacement is achieved by rotating the outer nozzle tube around the inner nozzle body using a guide contour with complementary guide elements. The guide bodies thus transfer the rotation of the outer nozzle tube into a coaxial displacement. As the effect attachment is also connected to the outer nozzle tube, this also rotates, and thus, the water image of the individual jets is divided by it. A large number of variable water images can be created in this way.

The fountain attachment, according to the invention, can also be used advantageously in combination with adjustable nozzles, in which an inner and an outer nozzle tube are supplied with water by two independently controllable pumps. The independent application of water to the inner and outer nozzle tubes creates variable water images in conjunction with an effect attachment.

Especially for large fountain shows, many different water images can be created by using different effect attachments, even when only one basic nozzle model is used.

Further features of the invention result from the claims, the figures and the description of the figures. All the features and combinations of features which are mentioned above in the description, and the features and combinations of features which are mentioned in the following text in the description of the figures and/or are shown only in the figures and can be used not only in the respective specified combination, but rather also in other combinations or else on their own. These and/or other objects, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Further modifications and embodiments of the invention can be derived from the following description of the subject matter and the drawings. The invention is now to be explained in more detail with reference to exemplary embodiments. Moreover, further advantages and details are shown in the claims and in the embodiment examples shown in the drawings:

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

In the drawings:

FIG. 1 shows a perspective view of a fountain attachment according to the invention of a cutting unit viewed obliquely from the front;

FIG. 2A shows effect attachment 1A;

FIG. 2 B shows effect attachment 1B;

FIG. 2 C shows effect attachment 1C;

FIG. 2 D shows effect attachment 1D;

FIG. 2 E shows effect attachment 2;

FIG. 3A shows a sectional view of the effect attachment shown in FIG. 2 A;

FIG. 3 E shows a sectional view of the effect attachment shown in FIG. 2 E;

FIG. 4 shows a longitudinal sectional view of the object in FIG. 1;

FIG. 5 shows the object from FIG. 4 in a different adjustment position than that of the nozzle;

FIG. 6 shows the object from FIG. 4 with the water image indicated:

FIG. 7 shows the object from FIG. 5, with the water image indicated:

FIG. 8 shows a fountain attachment similar to FIG. 5, but with an alternative adjustable nozzle; and

FIG. 9 shows a perspective view of a fountain attachment according to the invention in perspective view with an effect attachment different from that in FIG. 1.

The illustrations are merely examples of embodiments of the invention. The invention is by no means limited to these. Where possible and appropriate, corresponding components in the figures are provided with matching reference numbers, although not all components are labeled in every figure.

An artisan of ordinary skill in the art need not view, within isolated figure(s), the nearly infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit the basic operation of the present invention unless otherwise indicated.

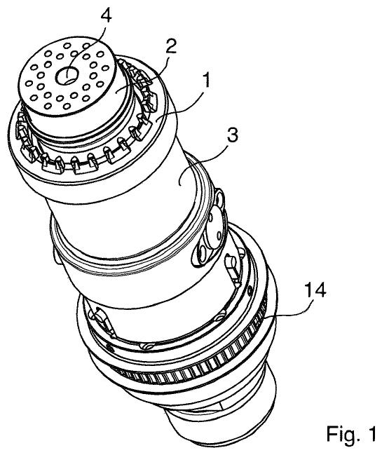

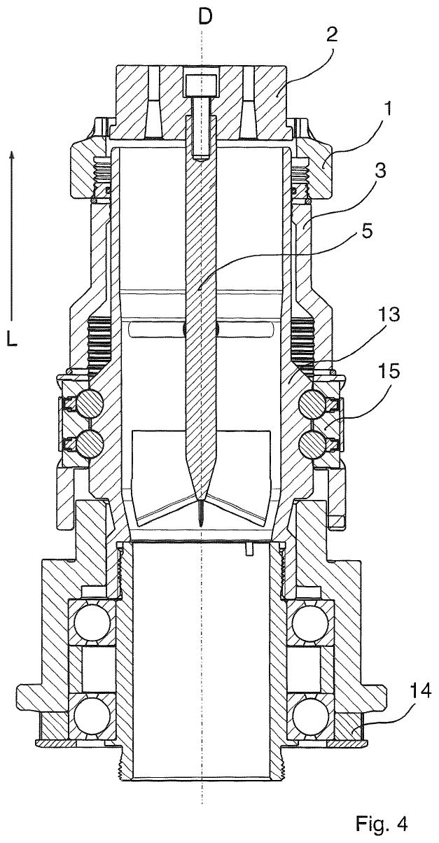

The fountain attachment shown in FIG. 1 is provided in the area of its nozzle outlet with an effect attachment I designed as an effect ring and an effect attachment 2 designed as a nozzle plate. Details on the function of the adjustable nozzle will be described later with reference to the sectional views in FIGS. 4 to 7.

In the embodiments shown in FIGS. 1 and 4 to 8, the effect attachment 1, which is designed as an effect ring 1, is screwed onto an outer nozzle tube 3. The nozzle tube 3 has an external thread at the upper end, while the effect ring I has a corresponding internal thread. The effect attachment 2, which is designed as a nozzle plate 2, is screwed to an inner nozzle body 5 via a central bore 4 in the embodiment example.

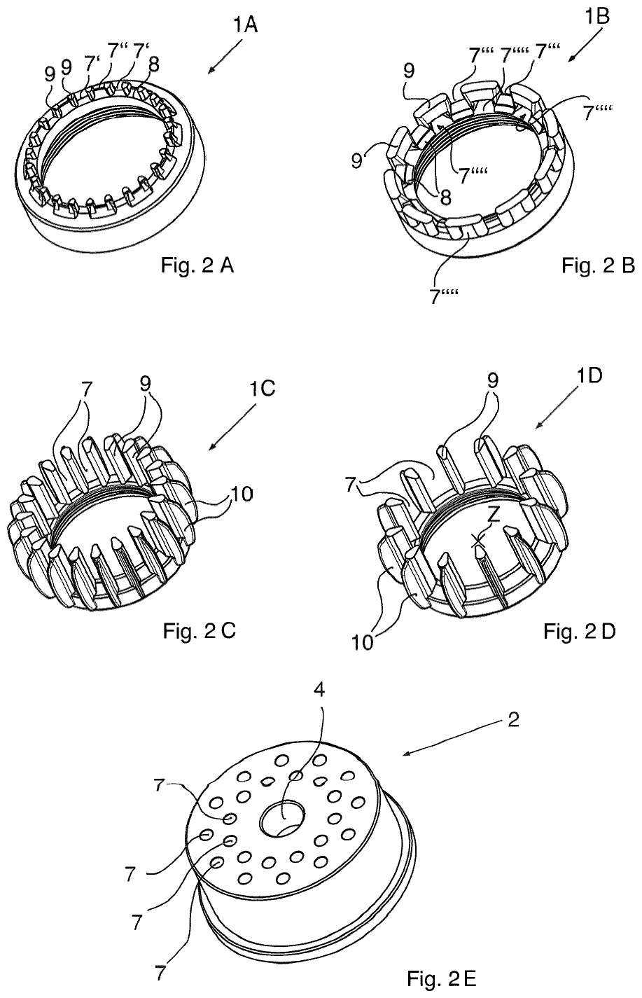

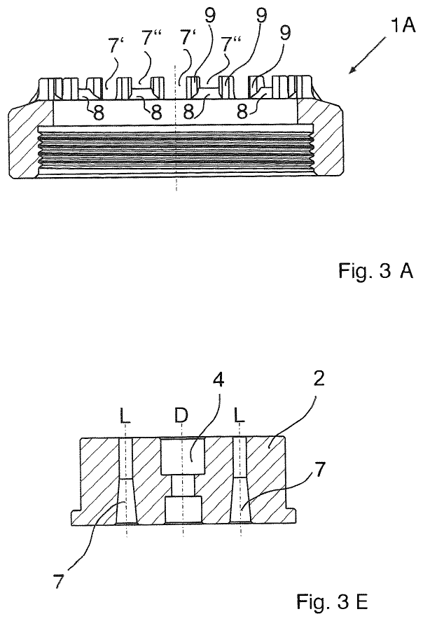

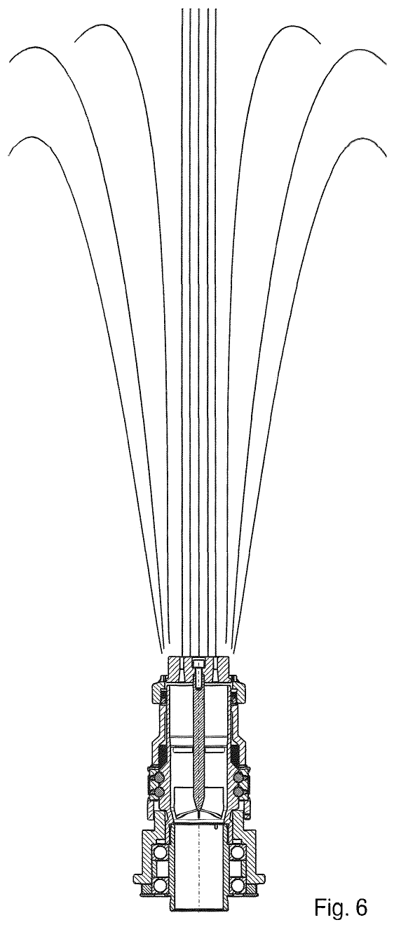

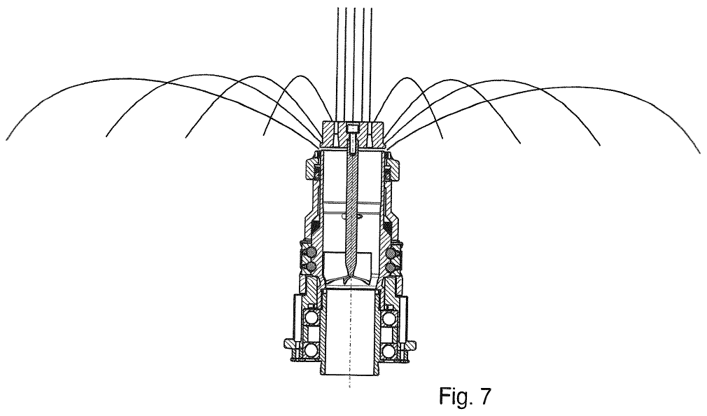

FIGS. 2 and 3 show different effect rings 1A to ID and an effect attachment 2 as nozzle plate 2. All the effect elements 1,2 shown have a number of apertures 7, which divide a water jet into individual jets (see FIGS. 6 and 7). These apertures 7 can be designed very differently, as the effect attachments 1,2 show. For example, the apertures 7 can have different sizes, different heights and different positions within the effect attachment 1,2, among other things. For example, the apertures 7 in the effect attachment 1A have different shapes and different heights. Thus, as can be seen in particular in FIG. 3A, a ramp-like element 8 leads to each second aperture 7″, which reduces the height of the aperture 7″ compared to the adjacent aperture 7′. Due to the ramp-like element 8, a water jet passing through the aperture 7″ is directed further upwards than the adjacent water jet passing through one of the apertures 7′.

The apertures 7 in the effect ring 1B are designed differently. The apertures 7 have approximately the same size all the way around, but are arranged at different heights. While ramp-like elements 8, in turn, lead to the apertures 7″, which are open at the top, the apertures 7″ extend under bridge-like separating elements 9 and thus allow water jets to form below the water jets released by the apertures 7″.

Effect rings 1C and 1D generate uniform individual jets over the entire circumference, the jet height of which does not differ as with effect rings 1A and 1B. For this purpose, the effect rings 1C and 1D have separating elements 9, which are arranged around the circumference like lamellae. They taper radially inwards towards the center Z of the nozzle outlet and are also designed with flow-optimized radii in the embodiments shown. On the outer sides of the separating elements 9 viewed from the center Z, these merge into jet guiding elements 10 in the illustrated embodiments 1C and 1D, which provide better guidance for the resulting individual jets. These jet guiding elements 10 can also extend downwards beyond the outer circumference of the fastening area of the effect ring 1 in some areas, as shown.

FIGS. 2E and 3E show an effect attachment 2 in the form of a nozzle plate 2, which is perforated by a plurality of apertures 7 in the longitudinal direction L of the nozzle, i.e., parallel to the longitudinal axis D of the nozzle. In analogy to the effect rings 1, the apertures 7 are also larger here towards the lower water inlet side in FIG. 3E and taper towards the upper water outlet side in FIG. 3E. This results in both a more even water inlet and a concentrated jet outlet. The central bore or hole 4, through which the nozzle plate 2 is fixed to the inner nozzle body 5 by means of a screw, can be seen centrally in FIG. 3E, as shown in FIGS. 4 to 8.

FIGS. 4 to 7 show the fountain attachment in the longitudinal section. In this embodiment, the nozzle is basically adjustable by moving its outer nozzle tube 3 relative to an inner nozzle tube 13 containing the inner nozzle body 5. This displacement movement is initiated by the inner nozzle tube 13 being driven in rotation by a belt wheel 14. In its outer wall, the inner nozzle tube 13 has two guide contours extending like waves over its outer circumference, in which ball modules 15 slide as guide counter-elements, which in turn are connected to the outer nozzle tube 3 and also raise and lower the outer nozzle tube 3 relative to the inner nozzle tube 13 like waves, i.e., transfer the rotational movement into a coaxial displacement. The basic nozzle essentially corresponds to a design as shown in DE 10 2018 119 424 A1.

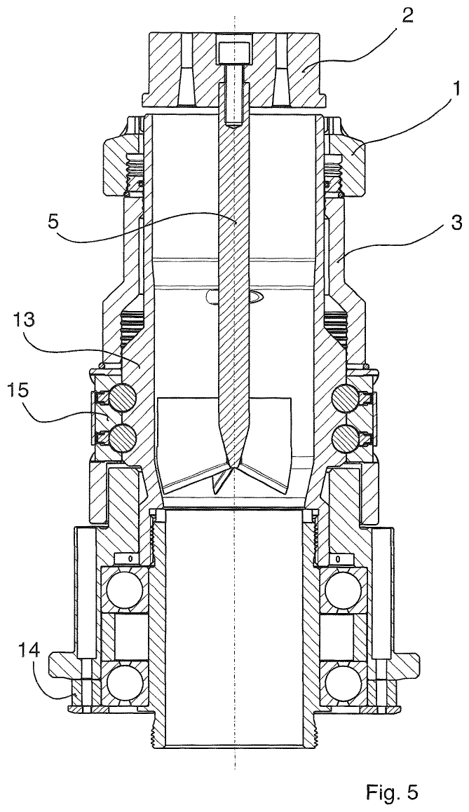

FIGS. 4 and 6 show the fountain attachment with the outer nozzle tube 3 in the maximum raised position, whereby the water jets divided by the effect ring are quite flat. In FIGS. 5 and 7, on the other hand, the outer nozzle tube 3 is in the lowest position opposite the inner nozzle tube 13, so that the outer individual jets can emerge high upwards.

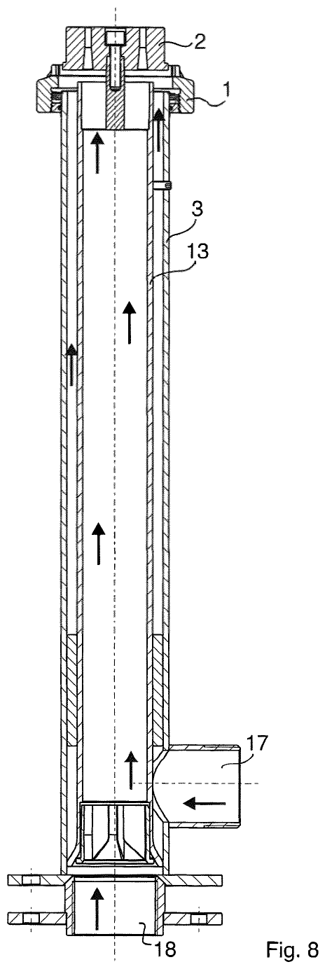

FIG. 8 shows another embodiment of the base nozzle of a fountain attachment according to the invention in a sectional view as in FIG. 4. In the embodiment shown in FIG. 8, a variable water spray nozzle similar to the embodiment in DE 10 2013 005 972 A1 is used as the basic nozzle. In addition to the choice of effect ring 1 and effect element 2, a variance in the generated water images can be created by the different water supply and the water pressures at the independently controllable pumps, which feed the completely separate pump connections 17 and 18.

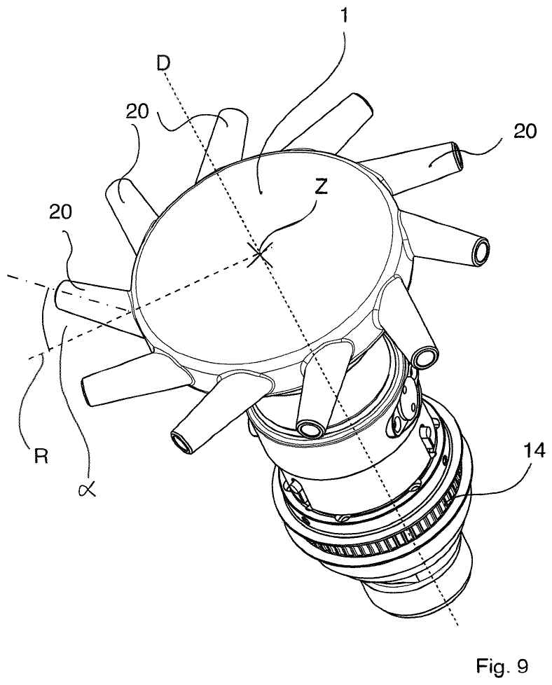

FIG. 9 shows a further embodiment of the fountain attachment according to the invention, which differs from FIG. 1. In this embodiment, the effect attachment 1 is designed as a rotating nozzle with outwardly directed outlet channels 20. These can extend radially outwards or, as shown in the embodiment in FIG. 9, be inclined relative to a radial R. In the embodiment shown, this inclination is shown at an angle a. This inclination should be a projection onto an imaginary plane perpendicular to the longitudinal axis D of the nozzle. Embodiments in which the outlet channels 20 do not extend perpendicular to the longitudinal axis of the nozzle are also included. Not only as shown here, but also the outlet channels 20 can be curved as well as linear and conical or cylindrical.

By combining a variable water spray nozzle with individually selectable effect attachments designed according to the invention, the fountain attachment according to the invention makes it possible to create extremely varied and dynamic water images with just a few basic elements.

The invention is not restricted to the above exemplary embodiment. It does not pose any difficulties to a person skilled in the art to modify the exemplary embodiment in a way which appears suitable to them, in order to adapt it to a specific application.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements that are nearly ubiquitous within the art can replace or supplement any element identified by another reference character.

TABLE 1
List of Reference Characters

| | |
|---|---|
| 1 | Effect ring |
| 2 | Nozzle plate |
| 3 | Outer Nozzle tube |
| 4 | Central bore or hole |
| 5 | Inner Nozzle body |
| 7 | Apertures |
| 8 | Ramp-like element |
| 9 | Bridge-like separating elements |
| 10 | Guiding elements |
| 13 | Inner nozzle tube |
| 14 | Belt wheel |
| 15 | Ball modules |
| 17 | First pump connection |
| 18 | Second pump connection |
| 20 | Outwardly directed outlet channels |
| α | Angle |
| D | Longitudinal axis |
| L | Longitudinal Direction |
| R | Radial |
| Z | Center |

### GLOSSARY

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein, refers to slight variations in numerical quantities with respect to any quantifiable variable. An inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes a structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

1-17. (canceled)

18. A fountain attachment for water features having an adjustable nozzle for producing dynamic water images at a nozzle outlet comprising of a nozzle having at least one outer nozzle tube (3) and one inner nozzle body (5), including at least one effect attachment (1) which is detachably connected to the outer nozzle tube (3) in the region of the nozzle outlet and has a plurality of apertures (7) which divide a goblet-like water jet into individual jets.

19. The fountain attachment according to claim 18, wherein the plurality of apertures (7) of the effect attachment (1) are of different sizes and/or different shapes.

20. The fountain attachment according to claim 18, wherein the plurality of apertures (7) of the effect attachment (1) have different heights.

21. The fountain attachment according to claim 18, wherein the plurality of apertures (7) of the effect attachment (1) are located at different heights of the effect element (1) in a longitudinal direction (L) of the nozzle.

22. The fountain attachment according to claim 18, wherein the apertures (7) of the effect attachment (1) are spaced apart from one another by separating elements (9) which taper radially inwards towards a center (Z) of the nozzle outlet.

23. The fountain attachment according to claim 22, further comprising jet guiding elements (10) directed radially outwards, are connected to the separating elements (9).

24. The fountain attachment according to claim 22, further comprising jet guiding elements (10) that are shovel-like.

25. The fountain attachment according to claim 18, wherein the effect attachment (1) is an effect ring.

26. The fountain attachment according to claim 18, wherein the effect attachment (1) is screwed onto the outer nozzle tube (3).

27. The fountain attachment according to claim 18, further comprising at least one effect attachment (2) which is detachably connected to the inner nozzle body (5) in the region of the nozzle outlet and has a plurality of apertures (7) which divide a central water jet into a plurality of individual jets.

28. The fountain attachment according to claim 27, wherein the effect attachment (2) connected to the inner nozzle body (5) is a nozzle plate which is perforated by the apertures (7) in a longitudinal direction (L) of the nozzle.

29. The fountain attachment according to claim 27, wherein the effect attachment (1, 2) is designed as a rotating nozzle with outwardly directed outlet channels (20).

30. The fountain attachment according to claim 29, wherein the outlet channels (20) are each arranged inclined with respect to a radial (R).

31. The fountain attachment according to claim 29, wherein the effect attachment (1, 2) is rotatably mounted, and the arrangement of the outlet channels (20) causes a rotation of the effect attachment (1, 2) when the jet is applied.

32. The fountain attachment according to claim 27, wherein the effect attachment (1, 2) closes the nozzle at the nozzle outlet in a longitudinal direction (L) of the nozzle.

33. The fountain attachment according to claim 18, wherein the outer nozzle tube (3) and its inner nozzle body (5) are designed to be displaceable relative to one another in a longitudinal direction (L) of the nozzle to adjust the nozzle, in particular by rotating the outer nozzle tube (3) around the inner nozzle body (5), wherein a guide contour translates the rotation into a coaxial displacement.

34. The fountain attachment according to claim 18, wherein the inner nozzle body (5) is formed with an inner nozzle tube (13) and the inner (13) and the outer (3) nozzle tubes are connected to two independently controllable pumps which allow a variable and mutually independent supply of water for adjusting the nozzle.
